(19) United States
(12) Patent Application Publication
(10) Pub. No.: US 2014/0047562 A1
(43) Pub. Date: Feb. 13, 2014

(54) SELECTIVE PROVISIONING OF ONLINE MEDIA CONTENT

(71) Applicants: Sergey Stepanov, Sankt-Petersburg (RU); Vsevolod Kuznetsov, Sankt-Petersburg (RU)

(72) Inventors: Sergey Stepanov, Sankt-Petersburg (RU); Vsevolod Kuznetsov, Sankt-Petersburg (RU)

(73) Assignee: RAWLLIN INTERNATIONAL INC., Tortola (VI)

(21) Appl. No.: 13/570,774

(22) Filed: Aug. 9, 2012

(51) Int. Cl. G06F 21/24; G06F 15/16

(52) U.S. Cl. 726/29

(57) ABSTRACT

Providing for client-selected user authentication in relation to accessing or acquiring online media content is described herein. In response to an access request transmitted by a client device, a server can determine a type of request employed by the client device and identify a type of media playback device associated with the client. Identification can be based on information specified within the access request, information derived from information pertaining to the access request, information derived from stored associations between access request and types of playback devices, or suitable combinations thereof. Once identified, promotional content or service(s) can be allocated to a subscriber account in response to the access request satisfying one or more criteria. In this manner, a service provider can facilitate client-selection of a mode of user authorization, while incentivizing a particular type of playback device for acquiring content from or generally interfacing with the service provider.

### TECHNICAL FIELD

The subject disclosure relates generally to managing online media, and more particularly to selectively providing access to online media content or services in response to one or more criteria.

### BACKGROUND

Advancements in high-speed last mile access to the Internet has enabled consumers to greatly expand the scope and diversity of content they can receive through electronic communications. Likewise, advancements in networked storage space and multiple access server technology has enabled multimedia service providers to store and distribute larger and more diverse scope of content, starting with relatively small audio content like songs and ringtones, to larger podcasts, full length movies, and even longer video content. It is not hyperbole to say, therefore, that fixed electronic communication systems have become a backbone of industrial, commercial and personal communications worldwide. Likewise, mobile communication networks have provided voice and data communication functionality that have become near-ubiquitous for both business and personal communications throughout much of the world. Content-related communication, for audio/video entertainment, single player and multiplayer online games, and the like, has also become popular, utilizing the fundamental architecture of the Internet and associated webs or networks as the underlying data/content communication platform.

Content and service providers generally employ arrays of multi-access servers to handle client communication or content requests, provide encryption or other security, and to track usage for billing the content and services delivered to subscribers. For high data applications and related archiving, large capacity data storage devices are often utilized and configured to store this content, and in conjunction with the multi-access servers, permit access to stored content. Common modern examples of online content or services include multimedia content such as movies, episode-based television content such as sitcoms, news programs, and other audio/video content, as well as audio content, and even real time interactive audio/video content, single-player or multiplayer games, as well as communication services, blogs, online forums, e-mail, text messaging, multimedia messaging, and so on.

A popular interface between the service provider and the consumer is a subscriber account. A consumer provides identification information and establishes login credentials for purposes of identifying themselves and restricting access to the subscriber account. Upon authorizing access to a subscriber account, selected content or services requested via at a client device logged in to the subscriber account can be delivered over a network for consumption. This framework enables content providers to track the usage of a particular subscriber, to facilitate billing the account for content and services consumed via the account.

Online television content has become an increasingly popular application for online multimedia content/services. Network television services typically involve delivering audio and video content over a network connection (e.g., an Internet connection, an intranet connection, . . . ) to a multimedia playback device, such as a television. In turn, the playback device is configured to communicate via its own network connection, and receive and play multimedia content. Network television services provide several advantages over traditional broadcast or cable television services. First, network television content can generally be stored persistently on a network data store, and accessed through a multi-access server. This facilitates access and consumption of stored content concurrently by multiple client devices (e.g., network-enabled television, personal computer, laptop computer, smart phone, tablet computer, . . . ) at their own initiation; a provider of the network television content is not required to initiate a broadcast to an unknown number of client devices which may or may not be tuned in to the broadcast. This results in a far greater degree of consumer-directed control over content with far fewer independent dedicated channels (and radio/cable bandwidth) than are typically required for broadcast television services. Second, network television content can leverage existing network communication pathways, in effect reducing the overall infrastructure equipment associated with delivering television services, radio services, or other multimedia content services, and general network data services (e.g., web browsing, online shopping, . . . ) to consumers. Third, by leveraging public networks, like the Internet, and existing access infrastructure for those networks, a more direct connection between service provider and consumer is possible, with relatively direct client-server communication between the consumer and service provider. The result is more responsive, efficient and cost effective content delivery, benefiting both the service provider and consumer.

Because network multimedia content is managed via client-server communications over a network, client authorization and user verification procedures are employed to control client access to content. A server might, for instance, be provisioned to check that a client device is associated with a subscription account offered by a particular content provider. This allows a service provider to limit content delivery only to those users who have an agreement with the service provider, as well as protect intellectual property rights of content owners. As technology associated with consumer playback devices, and network access infrastructure change, providers typically adapt their services to achieve new possibilities made available by these technological changes. This evolution in technology is ongoing, and generates seemingly perpetual demand to expand upon or improve existing content or services to match these changes, and is one of many current challenges related to online multimedia content delivery.

### SUMMARY

The following description and the annexed drawings set forth in detail certain illustrative aspects of the disclosed subject matter. These aspects are indicative, however, of but a few of the various ways, or embodiments, in which the principles of the disclosed subject matter may be implemented. The disclosed subject matter is intended to include all such embodiments and their equivalents. Other advantages and distinctive features of the disclosed subject matter will become apparent from the following detailed description of the various embodiments when considered in conjunction with the drawings.

In one or more aspects of the subject disclosure, there is provided client-selected user authentication in relation to accessing or acquiring online media content. A client device can transmit a message comprising a request for user authorization for the online media content. Based at least in part upon the type of request employed, a content management server can perform one or more of a set of predetermined actions, according to this aspect(s) of the subject disclosure. In at least one such aspect, the content management server can perform one of the set of predetermined actions comprising allocating promotional content or service(s) to a subscriber account associated with the client device in response to the type of request satisfying a criteria. In this manner, a service provider can facilitate client-selection of a mode of user authorization, while incentivizing client association with a device or action related to the criteria.

In one or more additional aspects of the subject disclosure, a criteria for applying promotional content or services to a subscriber account can be related to client-selection of an authorization request that is pertinent to a playback device or type of playback device associated with the client device. The authorization request can be related to, for instance, a hardware or software function of the playback device. As one particular example of such a function, a video processing mechanism employed by the playback device can be one suitable relationship between hardware or software function of the playback device and mode of authorization request employed by the client device to access online media content (though other suitable relationships can exist as well). Accordingly, upon receiving an authorization request from a client device of a particular mode, a content management server can reference rules for allocating promotional content or services, and determine whether the particular mode is associated with promotional content or service(s).

According to still other aspects of the subject disclosure, a criteria for applying promotional content or services to a subscriber account can be related to information included within an authorization request. In some aspects, the criteria can be utilized to correlate respective content or service(s) of a set of promotional content or service(s) with respective playback device information. Thus, a content management entity can discriminate based on information pertaining to a playback device associated with an authorization request in determining whether to allocate promotional content or service(s), or what subsets of promotional content/service(s) is to be allocated. In at least one aspect, promotional content or service(s), such as one or more free or discounted movies, videos, series episodes, and so on, can be allocated for a network-enabled television submitting an authorization request, and not allocated for a computer, laptop computer, table computer, etc., submitting an authorization request. Various other examples of allocating or not allocating content, or amount or type of content allocated, are within the scope of the subject disclosure.

According to a further aspect, upon successful user authentication, a remote access option can be implemented for a subscriber account related to online media content. The remote access option can permit content, or promotional content or service(s), to be accessed through a secondary playback device. The secondary playback device can be a mobile device in at least one aspect. Further, access by the secondary playback device can be restricted to a predetermined communication channel. Such a channel can comprise access via a phone call, access via an e-mail message, access via a text message, short message service message, multimedia message service message, or the like, or a suitable combination thereof. Moreover, access can be conditioned on submission of predetermined login credentials. These login credentials can be stored by a content management entity and utilized to condition access to content by the secondary playback device or over the predetermined communication channel. In at least one aspect, content or promotional content or service(s) accessed through the secondary playback device can be different from the content or service(s) accessed through a playback device via an authorization request as described above (e.g., a primary playback device).

In still other aspects of the subject disclosure, provided is a system for managing online content. The system can comprise a communication component, e.g., a server, configured to receive a message from a client device that includes a request related to authorization to access content. Further, the system can comprise a parsing component configured to search the message for information satisfying a criteria related to selectively providing a subset of content or services to subscriber accounts associated with consuming the content. In addition to the foregoing, the system can comprise a provisioning component configured to link a service or content from the subset of content or services with a subscriber account associated with the client device, at least in part in response to the parsing component finding information within the message that satisfies the criteria.

In another aspect(s), the subject disclosure provides a method for managing online content. The method can comprise storing a set of network links to a set of media content or services, and receiving an authentication request from a client device related to accessing online content. Additionally, the method can comprise identifying an authentication process employed for the authentication request and comparing the identified authentication process to stored data that relates a set of authentication processes with a set of multimedia playback devices. Further to the above, the method can comprise deriving information indicative of a client multimedia playback device associated with the client device in response to the comparing.

In yet another aspect(s), the subject disclosure provides a system for managing online content. The system can comprise means for receiving and authorizing access requests for stored online multimedia content. Further, the system can comprise means for determining a type of playback device submitting an access request and means for associating respective types of playback devices with respective subsets of promotional content or services related to stored online multimedia content. In one or more aspects, the system can also comprise means for provisioning a subset of promotional content or services to a subscriber account related to stored online multimedia content in response to determining an access request submitted in conjunction with the subscriber account satisfies a criteria related to provisioning the subset of promotional content or services.

A non-transitory computer readable storage medium comprising computer-executable instructions that, in response to execution, cause a computing system including a processor to perform operations. Particularly, the operations can comprise obtain, by the computing system, a video processing technology of a video playback device associated with the computing system, and reference, by the computing system, a mode of user authentication particular to the video processing technology of the video playback device. Moreover, the operations can comprise the following: submit, by the computing system, a request related to a user authentication procedure to an authorization server associated with granting or denying access to online content; and receive, by the computing system, a response to the request comprising information particular to the user authentication procedure and usable in conjunction with the mode of user authentication particular to the video processing technology.

The following description and the annexed drawings set forth in detail certain illustrative aspects of the disclosed subject matter. These aspects are indicative, however, of but a few of the various ways in which the principles of the disclosed subject matter can be employed and the disclosed subject matter is intended to include all such aspects and their equivalents. Other advantages and novel features of the disclosed subject matter will become apparent from the following detailed description when considered in conjunction with the drawings.

### BRIEF DESCRIPTION OF THE DRAWINGS

FIG. 1 illustrates a block diagram of an example system that provides selective provisioning of online content in accordance with aspects disclosed herein.

FIG. 2 depicts a block diagram of a sample system for allocating promotional content/services in response to user authorization for a content account.

FIG. 3 depicts a block diagram of an example system for allocating promotional content based on video user authentication, according to an aspect.

FIG. 4 illustrates a block diagram of a sample system of employing digital rights management in conjunction with promotional content or services.

FIG. 5 depicts a block diagram of an example system for establishing secondary access to promotional content or services in a further aspect(s).

FIG. 6 illustrates a flowchart of an example method for selective provisioning of online content or services according to particular aspects.

FIGS. 7 and 8 depict a flowchart of a sample method for providing client-selected authentication for online media content or services, in other aspects.

FIG. 9 depicts a block diagram of an example computer-readable medium comprising computer-executable instructions to facilitate disclosed aspects.

FIG. 10 illustrates a block diagram of an example electronic computing environment that can be implemented in conjunction with one or more aspects.

FIG. 11 depicts a block diagram of an example data communication network that can be operable in conjunction with various aspects described herein.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing various aspects disclosed herein.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

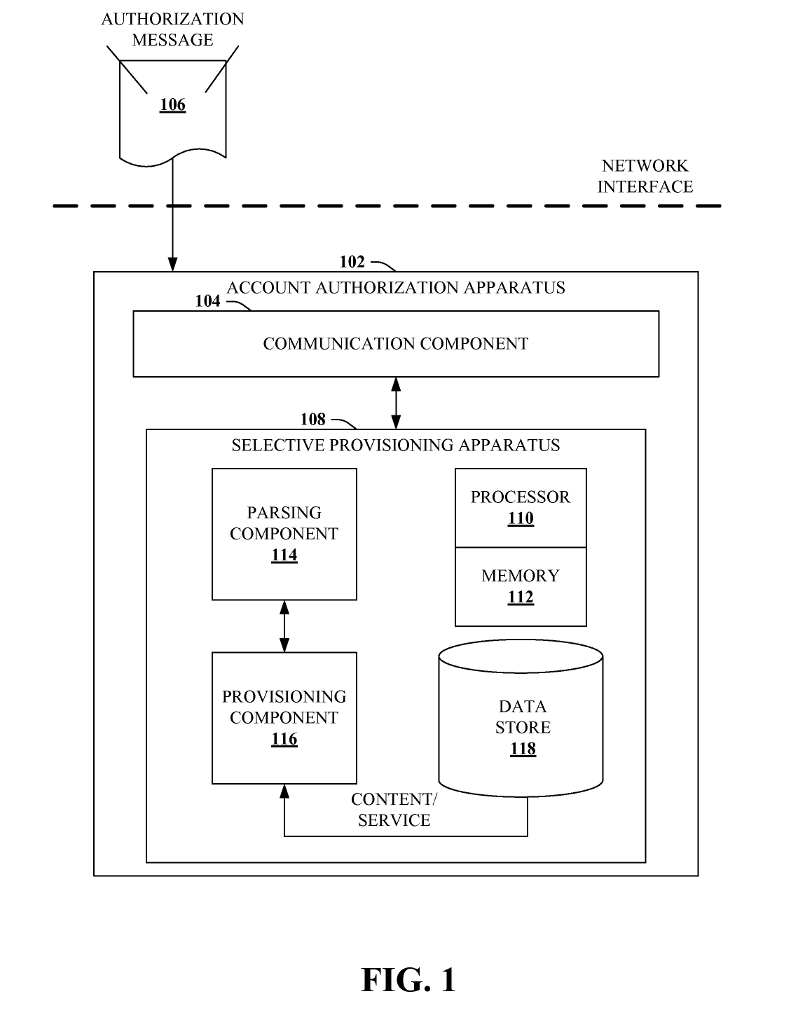

FIG. 1 depicts a block diagram of an example system 100 configured to facilitate user authorization for online content services, according to aspects of the subject disclosure. In some aspects, system 100 can facilitate client-selected user authentication and respond in a predetermined manner based on a user authentication mechanism employed by a client device. In at least one aspect, responding to the client-selected user authentication can comprise allocating promotional content or service(s) to a subscriber account associated with the client device. Allocating promotional content or service(s) can depend, for instance, on the mode of user authentication selected by the client device, on information included within an authorization request, on media playback equipment associated with the client device, or the like, or a suitable combination thereof. Accordingly, system 100 can be configured to be distinct from existing client-server authentication mechanisms, in which a server selects a mode of authentication, not the client. Client selection of authentication mode can, of itself, provide some information to the server about the client, enabling the server to respond with one of a set of actions related at least in part to respective client-selected modes of authentication. Said differently, in a client-server network interaction, system 100 can facilitate identification of a client based on a distinct functionality or property of the client, and is not limited to server responses based on a predefined list of client devices with which to recognize a incoming client message.

System 100 can comprise an account authorization apparatus 102 configured for receiving an authorization request at a communication component 104 (e.g., a communication server) from a client device (not depicted), over a network communication interface. The authorization request can be in the form of an authorization message 106. Particularly, authorization message 106 can employ any suitable communication protocol (e.g., transport control protocol/Internet protocol [TCP/IP], . . . ) for communicating with communication component 104 over a network.

Account authorization apparatus 102 can analyze authorization message 106 in relation to granting or denying access to an online multimedia content account associated with account authorization apparatus 102. Thus, for instance, account authorization apparatus 102 can determine whether a valid digital certificate is included with authorization message 106, or with a communication established in conjunction with authorization message 106. Validity of the digital certificate can be a prerequisite for accessing the online multimedia content account. The authorization request of authorization message 106 can also be analyzed for login credentials matching one or more accounts associated with account authorization apparatus, and so on. In response to determining authorization message 106 is a proper message or request, account authorization apparatus 102 can facilitate access to a matching online account. Otherwise, in response to determining authorization message 106 is not a proper message or request, access to the matching online account can be denied.

The authorization request included in authorization message 106 can be configured to be indicative of a client device requesting access to content or services associated with account authorization apparatus 102, a user or consumer operating the client device, a playback device or equipment associated with the client device, or the like, or a suitable combination thereof. Further, this indication can be employed to verify that the authorization request is a valid request, in one aspect (e.g., as described above). In another aspect, identification can be configured to verify that a client device, playback device, user, etc., is authorized to access a subscription account or the content or services related to such subscription account.

Account authorization apparatus 102 can comprise a selective provisioning apparatus 108. Selective provisioning apparatus 108 can be configured for analyzing authorization message 106 with respect to one or more criteria, and performing one or more actions in response to a determination that at least a subset of the one or more criteria are satisfied. Suitable actions can comprise, for instance, applying predetermined promotional or marketing strategies affecting a subscriber account of one or more content or service subscribers. Such strategies can include linking bonus content or services with a subscriber account, allocating reduced price or free content for consumption through the subscriber account, and so on. In addition, account authorization apparatus 108 can set one or more conditions on access to, or consumption of bonus content or services. A suitable condition can comprise, among other examples, accessing content on a particular type of media playback device, for instance.

Account authorization apparatus 102 can comprise a memory 112 for storing computer-executable components. Further, account authorization apparatus 102 can include one or more processors 110 communicatively connected to memory 112 and configured to facilitate execution of at least one of the computer-executable components stored in memory 112. Additionally, processor(s) 110 can access data stored in other components of selective provisioning apparatus 108 (e.g., data store 118), and facilitate execution of other computer-executable components of selective provisioning apparatus 108 (e.g., parsing component 114, provisioning component 116, data store 118).

Account authorization apparatus 102 can comprise a parsing component 114 configured to access and analyze authorization message 106 received by communication component 104. Particularly, parsing component 114 can be configured to search authorization message 106 for information satisfying criteria related to selectively providing a subset of content or services to a subscriber account(s) related to system 100. In some aspects, the criteria can relate to a media playback device associated with the client device or an associated subscriber account. Such a media playback device can include, for instance, a network-enabled television, a set-top box television receiver and display, a network-enabled disc player and television, computer, mobile communication device, smart phone, tablet computer, and so on. In one or more particular aspects, the criteria can relate to the media playback device being one of a set of predetermined types of media playback devices. In one specific aspect, the set of predetermined types of media playback devices can include a network-enabled television device. In an alternative, or additional aspect, the set of predetermined types of media playback devices can exclude a personal computer, a laptop computer or a workstation computer.

According to one or more further aspects, the criteria can relate to a video processing mechanism of a media playback device associated with authorization message 106 or a client device transmitting authorization message 106. Thus, for instance, in these aspects the criteria can specify membership within (or not within) a set of predetermined video processing mechanisms as satisfying or not satisfying the criteria. As a more specific example, the criteria could be based on whether the video processing mechanism of the media playback device is at least one of an operating system (OS)-based processing mechanism, an application-based processing mechanism or a browser-based processing mechanism, or the like, or a suitable subset or superset thereof. Accordingly, parsing component can be configured to search authorization message 106 for information indicative of a video processing mechanism employed by the media playback device for determining satisfaction of the criteria. In acquiring information from authentication message 106, parsing component 114 can analyze information included explicitly within authorization message 106, infer such information from other information included within authorization message 106, or infer such information from a mode or manner of authorization request employed by authorization message 106, or a suitable combination thereof. In at least one disclosed aspect, a mode of authorization request can be indicative of information pertaining to the media playback device associated with authorization message 106, or indicative of a type of video processing mechanism employed by the media playback device, or the like, or a suitable combination thereof.

In yet other aspects, the criteria can pertain directly or indirectly to the authorization request included within authorization message 106. As a further example, the criteria can pertain to a query for a video identification code related to user authentication at a client device or the media playback device. This can be applicable in the event that the client device submits a query to account authorization apparatus 102 for a video identification code for authenticating a user of the client device or media playback device. In such case, parsing component 114 can search authentication message 106 for information indicative of a query for a video identification code, and draw an inference from such a query concerning satisfying the criteria. As a simple example, if authentication message 106 includes a request for a video identification code, parsing component can infer that the media playback device is one of a set of media playback devices, or that the video processing mechanism is one of a set of related video processing mechanisms, and so on.

By analyzing authentication message 106 for information and determining or inferring other information pertaining to the criteria, parsing component 114 can facilitate selective actions by selective provisioning apparatus 108. By way of example, selective provisioning apparatus 108 can take a first subset of actions in response to the criteria being satisfied, and a second subset of actions in response to the criteria not being satisfied. In further aspects described below, selective actions can comprise provisioning a service(s) or content for a subscriber account(s), not provisioning the service(s) or content, selecting one or more subset of service(s) or content for provisioning, or the like, or a suitable combination thereof.

Account authorization apparatus 108 can further comprise a provisioning component 116. Provisioning component 116 can be configured to perform an action(s) in response to parsing component 114 determining that authorization message 106 satisfies predetermined criteria. In some aspects of the subject disclosure, the action(s) can be related to a marketing plan or other suitable promotional plan (referred to herein as the promotional plan) for subscriber accounts related to account authorization apparatus 102. As an example, the marketing or promotional plan can comprise allocating a bonus service or content to a subscriber account related to authentication message 106. Thus, for instance, provisioning component 116 can be configured to link a service or content from content or services related to the promotional plan that are stored in a data store 118 (where the content/services related to the promotional plan can be a subset of all content and services available from one or more service providers associated with account authorization apparatus 102). The linked content/service can be accessed or consumed by a user subject to one or more rules (e.g., limited number of downloads, limited number of views, limited to playback on a particular playback device or set of devices, or a set of devices having a particular video processing mechanism) in one aspect, or can be accessed or consumed without restraint, in another aspect.

As described above, system 100 can selectively provision content or services to one or more subscriber accounts at least in part based on one or more criterion related to an authorization message 106. Said differently, account authorization apparatus 102 can employ the authorization message 106 itself, or a mode of user authentication included within authorization message 106, in deriving information about a client device, and performing selective actions based on that information. This can improve client-server communication efficiency, by potentially reducing a number of exchanges there between. Moreover, selective provisioning can be updated by changing the criterion(ia), in accordance with a service provider's desires. This can provide flexibility in implementing a promotional plan related to provisioning online content or services, and adapting the implementation to fluctuations in consumer desires, purchasing patterns, and so on.

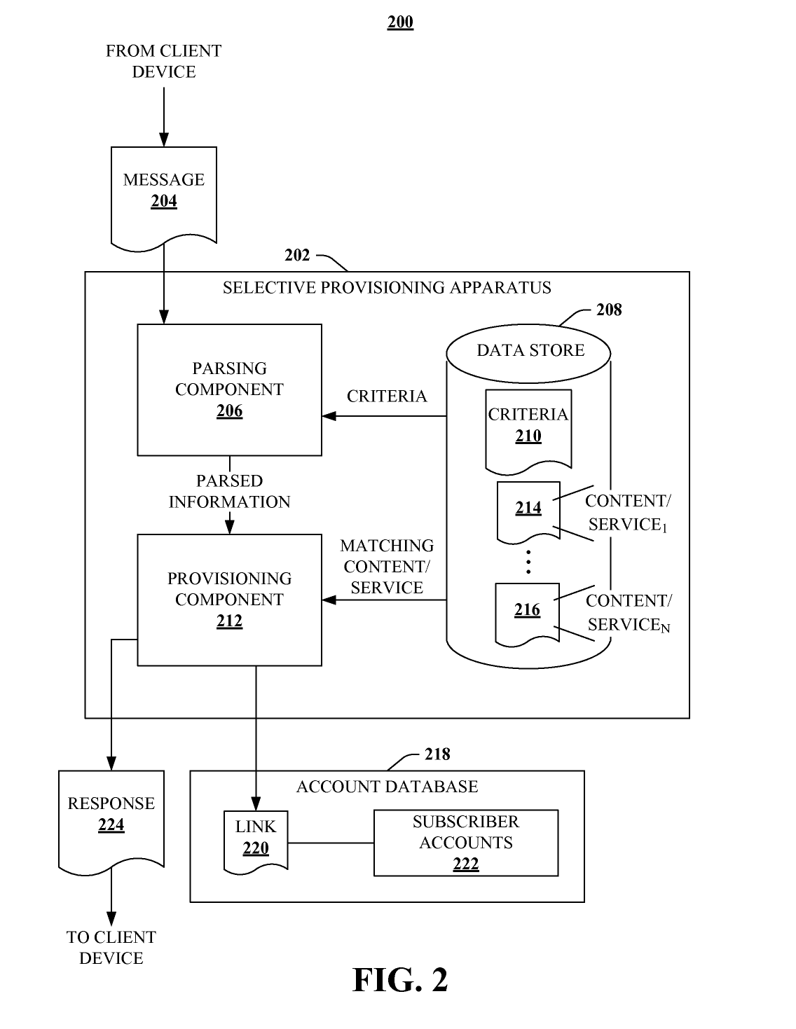

FIG. 2 illustrates a block diagram of an example system 200 for selective provisioning of media services or content in conjunction with managing multimedia subscriber accounts, according to further aspects of the subject disclosure. System 200 can comprise a selective provisioning apparatus 202 configured for allocating media content or services to subscriber accounts in response to satisfaction of predetermined criteria. Additionally, selective provisioning apparatus 202 can be configured for allocating different subsets of content or services for different subscriber accounts, in response to satisfaction of the predetermined criteria, a subset of the predetermined criteria, or additional criteria. Particularly, the criteria can be related to an authorization request (e.g., to obtain access to a subscriber account) or authentication procedure (e.g., to verify identity of a user of a device, or a user of a subscriber account) included within a message 104 transmitted by a client device. In at least one aspect, a mode of authorization/authentication can be indicative of a type of media playback device or playback processing technology employed by such device. In this latter aspect then, selective provisioning can be utilized to determine whether content or services should be allocated, or what content or services, based at least in part on type of playback device or functionality of such a device, without explicit communication to this effect.

Selective provisioning apparatus 202 can comprise a parsing component 206 configured to search message 204 for information satisfying one or more criterion. The criterion can be stored in a data store 208 in a criterion file 210, as depicted. Further, the information can be information included explicitly within message 204, or information pertaining to message 204, or information derived from message 204, or a suitable combination thereof.

Parsing component 206 can output results of an analysis of message 204 to a provisioning component 212. The results can include a set of parsed information pertaining to message 204, pertaining to an authorization request or authentication process included therein, pertaining to a client device transmitting message 204, pertaining to a media playback device associated with the client device, or the like, or a suitable combination thereof. Alternatively, the results can specify whether parsing component 206 has determined any criteria of criteria file 210 are satisfied by information derived from message 204, and if so, what criteria are satisfied.

Based on results provided by parsing component 206, provisioning component 212 can retrieve a reference (e.g., a name, a title, a memory address, . . . ) to a subset of content or services stored in data store 208. In addition, the reference to the subset of content or services can be transmitted as a response to message 204, indicating to the client device that content or services have been allocated to a subscriber account associated with message 204. Moreover, permission to access the subset of content or services can be linked with the subscriber account, facilitating user-initiated utilization/consumption of the subset of content or services. Further, rules can be linked with the permission to access, defining limitations on the permission to access or on the subset of content or services that can be accessed by the subscriber account. Rules can specify, as suitable examples, a number of times that particular content can be viewed, a number of discrete compositions of content (e.g., movies, videos, songs, ringtones, . . . ) that can be consumed under one or more access or billing conditions (e.g., at a reduced rate, at no charge, . . . ), and so on.

In some aspects of the subject disclosure, respective subsets of content or services, including content/service₁ 214 through content/service_{N} 216 (referred to collectively as subsets of content/services 214-216), can be stored as separate files in data store 208. These separate subsets of content/services 214-216 can be pre-allocated to particular criteria or subsets of criteria stored in criteria file 210, in one aspect. For instance, in response to detecting satisfaction of a first criteria, content/service₁ 214 can be allocated to a subscriber account, whereas in response to detecting satisfaction of a second criteria, content/service₂ 216 can be allocated to the subscriber account instead. In other examples, combinations of subsets of content/services 214-216 can be allocated to the subscriber account in response to satisfaction of a third criteria or a combination of criteria stored in criteria file 210. Some specific examples to illustrate the relationship between criteria pertaining to message 204, and subsets of content/services 214-216 that can be allocated to a subscriber account associated with message 204 are given below.

As one illustrative example, a first criteria can be equated to detection of a particular type of user authentication request (e.g., a request for video identification code) pertaining to message 204. Upon satisfaction of the first criterion, content/service₁ 214 can be allocated to an associated subscriber account, which can include a number of free movie selections (e.g., ten movies that can be selected through a subscriber account and viewed without charge). Thus, in the event that parsing component 206 detects the particular type of user authentication request in relation to message 204, provisioning component 212 can reply to message 204 indicating the availability of the number of free movie selections, and can establish a link to the free movie selections from the subscriber account to facilitate access thereto.

As a second illustrative example, a second criterion can be equated to detection of a type of media playback device associated with a client device transmitting message 204. In one aspect, detection of the type of media playback device can be inferred from a type of user authentication request (e.g., the request for video identification code); however this example need not be limited to this aspect. Further, content/service₁ 216 can be linked with satisfaction of this second criteria, and can comprise access to an online application. The access can be at a reduced charge or no charge, in some aspects. In alternative, or additional aspects, the access can be for a limited time (e.g., one month, one billing cycle, . . . ) or for a limited quantity of usage (e.g., 100 application sessions, . . . ), or the like. Suitable online media applications could include an online gaming platform, an online movie service, an online television show service, an online shopping service, and so on.

Upon identifying a subset of content/services 214-216 matching a satisfied criterion(ia), provisioning component 212 can receive a reference (e.g., a link, a description, . . . ) to the matching subset of content/services from data store 208. The reference can be included in a response message 224 transmitted in reply to message 204. Additionally, provisioning component 212 can access an account database 218 related to managing or storing information pertinent to online content subscriber accounts 222 for an online media system related to system 200. Provisioning component 212 can be configured to create a link 220 between one of subscriber accounts 222 and the matching subset of content/services 214-216. Link 220 can be configured to enable access to the matching subset of content/services 214-216 through the one of subscriber accounts 222, and a suitable client device or media playback device logging into such one of subscriber accounts 222.

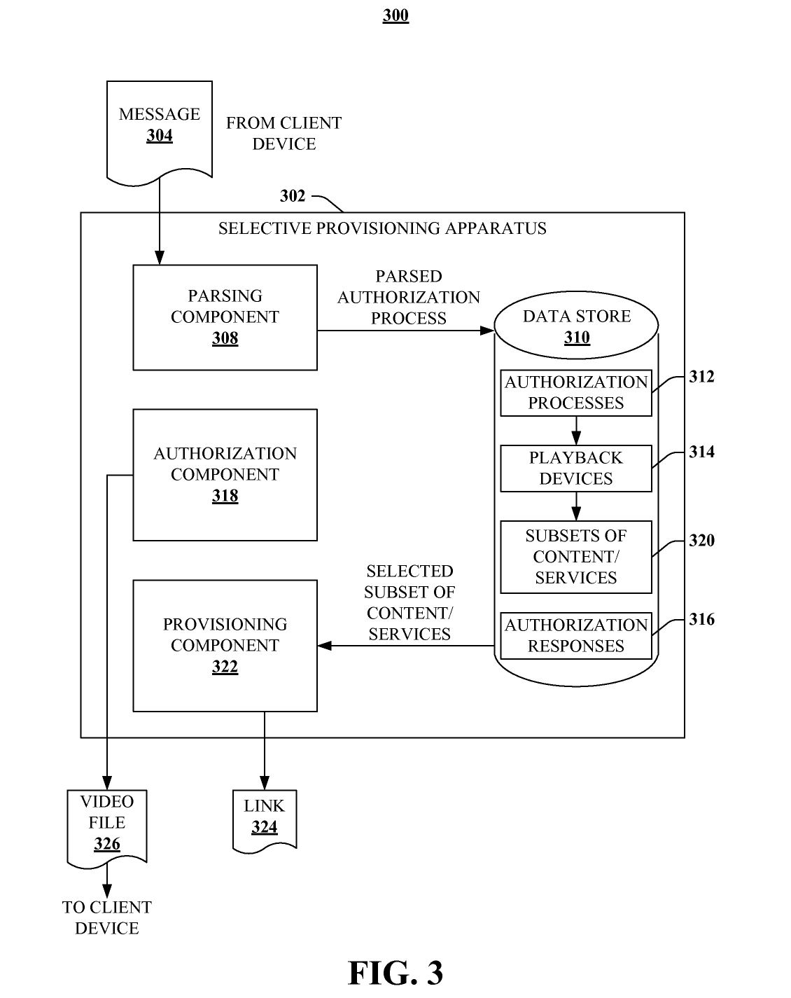

FIG. 3 illustrates a block diagram of an example system 300 for selective allocation of promotional content or services as part of an online multimedia service, according to one or more particular aspects of the subject disclosure. Online multimedia service providers may have one or more preferred products or services, or mechanisms for delivering these products/services. Scope and rationale for such a preference can be caused by a variety of circumstances, including supplier costs, market demand, and so on. Yet to be competitive a service provider may also need to provide options that are not preferred. Thus, it can be useful to have a consumer incentive to entice subscribers to select the service provider's preferred content or delivery mechanisms, rather than non-preferred options. Allocation of promotional content or services can be such a consumer incentive, and when allocated selectively can cause subscribers to choose a provider's preferred business model over a non-preferred model.

As a particular example of the foregoing, an online multimedia service provider may prefer to deliver media content for consumption on a particular playback device. For instance, a television device (e.g., network-enabled television, network-enabled set-top box connected to a television display, . . . ) may be preferred over a computer, laptop computer, tablet computer, etc., for delivery of multimedia content. This can be for a variety of reasons, ranging from features of a preferred display device—resulting in a more enjoyable viewing experience and consequently greater demand for the provider's content—to supplier discounts or third party agreements related to consumption of content on the particular playback device (e.g., a television manufacturer may achieve higher sales when subscribers in general view content more often on a television rather than a multi-purpose computer).

To provide a consumer incentive to employ a particular multimedia playback device, system 300 can be configured to selectively allocate promotional content or services for content usage utilizing the particular multimedia playback device. To accomplish this, system 300 can be configured to determine or infer a type of multimedia playback device utilized for viewing content. This determination can be directed toward a user authentication process, in which a display device attempts to authenticate a user for accessing a subscriber account maintained by a content provider. Further, the user authentication process is often a point at which subscribers intend to access and view content. Thus a device performing the user authentication is also likely to be the playback device employed for viewing the content, and analyzing the user authentication process for playback device type will likely identify the actual device upon which the content is viewed. In some cases, a type of authentication process employed can be dependent upon capabilities of the playback device, which can identify a type of the playback device. For instance, in the event that a video identification code is requested, the request may include a particular video format, playback protocol, etc., for the video identification code. Such a particular request can provide a logical basis for inferring a type of video processing mechanism employed by the playback device (e.g., OS-level video processing, application-level video processing, browser-level video processing, . . . ) which in turn can be indicative of the type of the playback device (e.g., network-enabled television, computer, . . . ). Accordingly, the authentication process requested, or particular information within the authentication process can be utilized by system 300 to determine or infer the type of multimedia playback device utilized for viewing content.

System 300 can comprise a selective provisioning apparatus 302 configured to analyze a message 304 related to authenticating a client device transmitting message 304, or a user thereof, with a multimedia content service provider. A parsing component 308 can be employed to analyze message 304 for the purpose of identifying a type of multimedia playback device that is associated with the client device. The identification can be performed by analyzing explicit information within message 304 (e.g., explicitly identifying the multimedia playback device as some form of device), drawing an inference(s) from explicit information within message 304 (e.g., inferring that an explicit request for a video identification code implies a playback device compatible with video identification code user authentication, . . . ), or drawing an inference(s) from contextual information pertaining to message 304 or contextual information pertaining to the explicit information within message 304 (e.g., inferring that a request for a type of video authentication file implies a playback device compatible with playing the video authentication file, . . . ).

In at least one aspect of the subject disclosure, a data store 310 can store a list of authorization processes 312 (e.g., for obtaining access to a subscriber account) and store an associated list of multimedia playback devices 314. The association can include, for instance, a list of multimedia playback devices compatible with one or more of the respective authorization processes 312, as one example. Further, data store 310 can correlate respective multimedia playback devices 314 with respective subsets of promotional content/services. This correlation can, for instance, specify respective subsets of content/services for allocation to a subscriber account in response to detecting respective correlated ones of multimedia playback devices 314 being related to message 304, as one example.

Authorization processes 312 can comprise client-server processes pertaining to accessing a subscriber account, or the content or services allocated to a associated subscriber account, in some aspects of the subject disclosure. In at least one aspect, authorization processes 312 can alternatively or additionally comprise user authentication processes, which as utilized herein refer to a process for identifying a user of a client device or multimedia playback device as being a human as opposed to a computer, or bot. A user authentication process can be conducted locally at the client device or multimedia playback device, or can be conducted in a client-server manner.

As indicated above, data store 310 can store a correlation(s) between one or more of authorization processes 312 and one or more of multimedia playback devices 314 that are compatible with the respective authorization processes 312. In this aspect(s), parsing component 308 analyzes message 304 to identify an authorization process contained therein. Provisioning component 322 can employ the identified authorization process for referencing a playback device file 314 and identifying a playback device(s) 314 correlated with the identified authorization process. Moreover, provisioning component 322 can also retrieve one or more subsets of content/services 320 that are correlated with the identified playback device (if any). In response to identifying a subset of content/services 320 is associated with an identified multimedia playback device 314, provisioning component 322 can obtain a reference to the subsets of promotional content/services 320, and transmit the reference in reply to message 304. Furthermore, provisioning component 322 can establish a link 324 between the subsets of promotional content/services and a subscriber account associated with message 304, facilitating access to and consumption of the promotional content/services via the subscriber account.

In addition to the foregoing, an authorization component 318 can be employed for responding to an authorization request (or a user authentication request) included with message 304. Authorization component 318 can be configured, for instance, to determine whether suitable subscriber account login credentials are included within message 304, and if so, grant access to an associated subscriber account in response to message 304. If no suitable subscriber account login credentials are present, authorization component 318 can instead reject access in response to message 304.

In a particular aspect, authorization component 318 can be configured to facilitate user authentication related to message 304. Particularly, in response to parsing component 308 identifying a query for a video identification code within message 304, authorization component 318 can be configured for responding to such a query with the video identification code. To this end, authorization component 318 can be configured to generate an authorization code. The authorization code can be generated at least in part from information included within message 304, information derived from message 304 (e.g., information obtained from a subscriber account identified via information specified in message 304), or the authorization code can be generated independent from information related to message 304 (e.g. the authorization code can be generated from a code generation algorithm that does not employ information from message 304 for generating such a code). Authorization component 318 can then create a picture file comprising a picture (e.g., a graphic) of the authorization code, and convert the picture file into a video file 326. Video file 326 can then be transmitted in reply to message 304 to facilitate use of the video identification code in conjunction with a user authentication procedure.

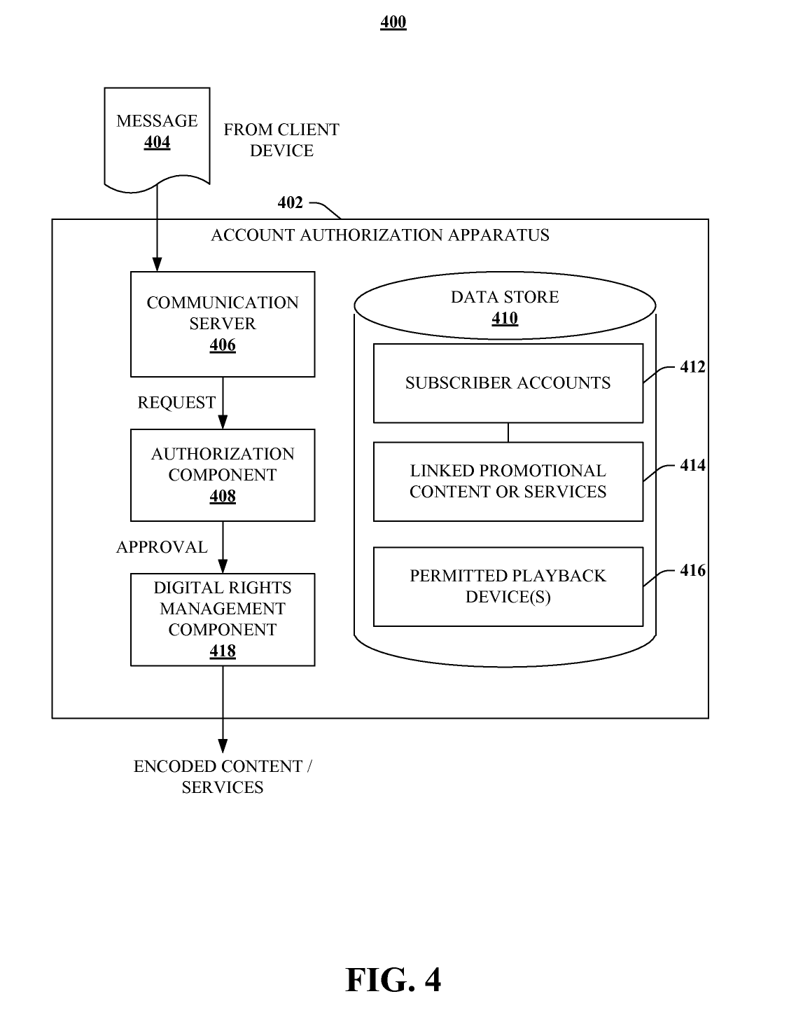

FIG. 4 illustrates a block diagram of an example system 400 for providing encoded content/services in conjunction with various aspects of the subject disclosure. Encoding can comprise, for instance, digital rights management (DRM) encoding for the purpose of limiting use of transmitted information to DRM-enabled playback devices. Although other encoding formats can be employed for similar or unrelated purposes, the following discussion of encoded content/services is directed toward digital rights management encoding.

System 400 can comprise an account authorization apparatus 402. Account authorization apparatus 402 can be configured to communicate over a network with remotely located computing devices (e.g., client devices) in conjunction with facilitating access to a set of subscriber accounts for client devices (or users) authorized to access and utilize respective ones of the set of subscriber accounts. Account authorization apparatus 402 can also be configured to reject access to the set of subscriber accounts for client devices (or users) that are not authorized to access and utilize a particular subscriber account. Thus, account authorization apparatus 402 can comprise a communication server 406 for transmitting and receiving electronic messages over a communication network. As one example, communication server 406 can be configured for receiving a message 404 related to accessing a subscriber account or accessing content or services pertaining to a subscriber account(s). A request for access to a subscriber account received within message 404 can be forwarded to an authorization component 408.

In one aspect of the subject disclosure, authorization component 408 can be configured to grant or deny access to a subscriber account in response to a proper or improper, respectively, login to the subscriber account. Authorization component 408 can reference subscriber account information stored in a subscriber accounts file 412 of a data store 410 to facilitate determining propriety of a login request (e.g., message 404). As an example, authorization component 408 can reference an account name, password, or other suitable login credentials from message 404 and match the login credentials with stored information at subscriber accounts file 412. If a suitable match is found, an approval can be provided to a DRM component 418, in some aspects of the subject disclosure. DRM component 418 can be configured to encode a reply to message 404 with a DRM protocol, thereby limiting access to the matching subscriber account to a client device that can decode the DRM-encoded reply.

In addition to the foregoing, data store 410 can store information pertaining to promotional content or services linked with subscriber accounts related to system 400. Such information can be stored in a linked promotional content or services file 414 and can specify promotional content or services accessible to respective ones of a set of subscriber accounts maintained by subscriber accounts file 412. In response to successfully logging in to a subscriber account, content or services linked with the subscriber account can be made available to a client device logged into the subscriber account. In at least one aspect, the content or services made available can be encoded by DRM component 418 with the DRM protocol, as described above, to limit consumption of the content or services to DRM-enabled devices. Usage restrictions on promotional content or services established by a content service provider can be monitored at linked promotional content or services file 414, to keep track of limited number of content views, limited duration of content/service access, or the like.

Furthermore, limitations on playback devices permitted to access subsets of linked promotional content or services file 414 can be stored at a permitted playback device(s) file 416. More particularly, permitted playback device(s) file 416 can store an association between respective playback devices (e.g., type of playback devices, playback device video processing mechanisms, or like differentiations, or a suitable combination thereof) and one or more types, categories, etc., of promotional content or services which respective playback devices are permitted to access. Thus, as an example, if a service provider establishes a restriction limiting access to promotional full-length feature movies for television devices (e.g., standard definition or high definition television, set-top receiver box and display, satellite receiver box and display, . . . ), permitted playback device(s) file 416 can record this restriction for a subset of linked promotional content or services 414 that qualify as full-length feature movies. To enforce playback device restrictions, a type of playback device associated with message 404 can be determined in response to receiving message 404. This determination can be made by authorization component 408, in some aspects of the subject disclosure, or can be made by a separate entity as described elsewhere herein (e.g., selective provisioning apparatus 302 of FIG. 3, supra, selective provisioning apparatus 202 of FIG. 2, supra, account authorization apparatus 102 of FIG. 1, supra, . . . ). Once an associated playback device is determined, a playback-device restriction established by permitted playback device(s) file 416 can be enforced. Permitted playback devices and applicable content/service restrictions can be checked for each content/service request, or for each subscriber login session (and enforced for each content/service request for a login session), or the like.

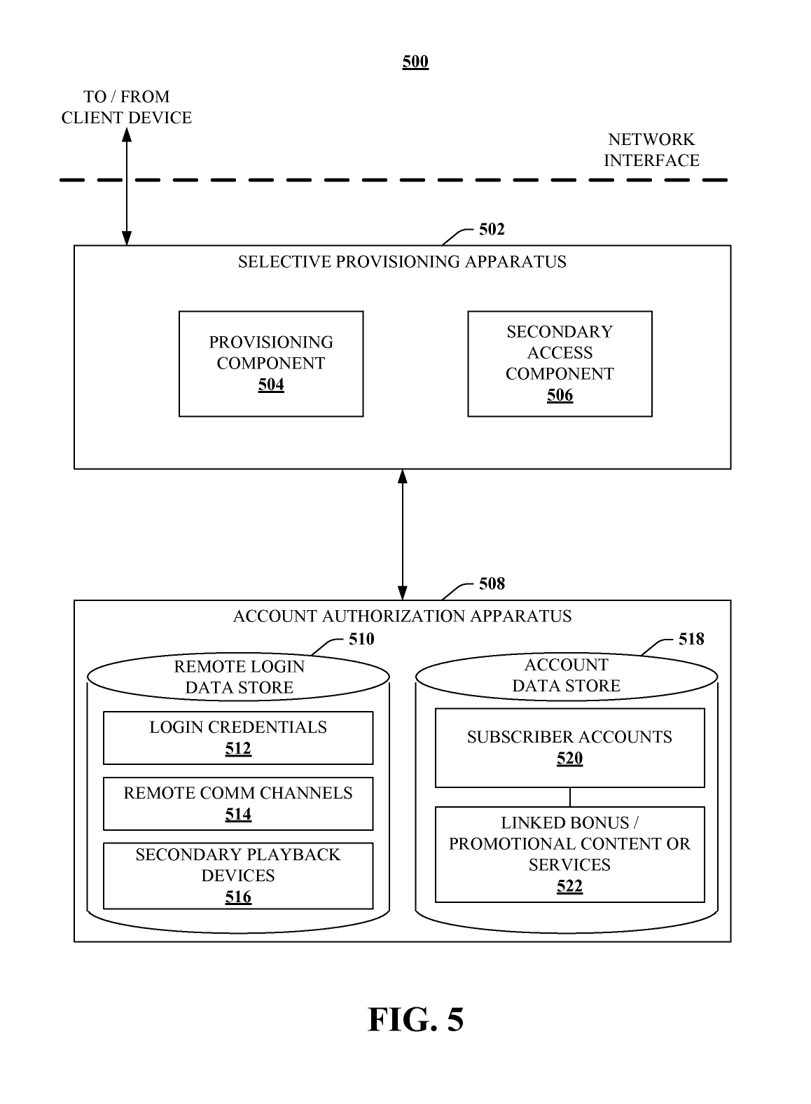

FIG. 5 illustrates a block diagram of an example system 500 that facilitates alternate access to media content or services associated with a media subscription account. In some aspects, the alternate access to media content or services can be provisioned for a secondary playback device, in lieu of or in addition to a primary playback device established for the media subscription account (e.g., a television device at a subscriber's home, or a set of such devices). In other aspects, the alternate access to media content or services can be provisioned in conjunction with a network communication channel. In still other aspects, a combination of the foregoing alternate access provisions can be implemented.

System 500 can comprise a selective provisioning apparatus 502 communicatively connected with an account authorization apparatus 508. Selective provisioning apparatus 502 can be configured for establishing alternative or additional modes of accessing online content or services associated with an online media subscription account. In one aspect, the alternative or additional modes of accessing online content or services can be limited to promotional content or services allocated to the online media subscription account by a provisioning component 504, for instance in response to client-selected user authorization or user authentication process, as described herein. However, in other aspects, the alternative or additional modes of accessing online content or services can extend to any suitable subset of content or services associated with the online media subscription account.

A secondary access component 506 can communicate with a client device (e.g., a user device) over a network interface, to receive information, instructions or parameters related to establishing an alternative/additional mode of accessing online content or services. Such information can be stored at a remote login data store 510 of an account authorization apparatus 508. Account authorization apparatus 508 can then grant access to a login request, or media access request that complies with the information, instructions or parameters stored in remote login data store 510, for instance.

In at least one aspect, login and content access functionality for remote login can be based at least in part on information and rules for accessing content or services associated with a subscriber account. Such information and rules can at least in part be predetermined by system 500, or can at least in part be established by a user communicating with secondary access component 506 over the network interface. Suitable rules or information can include, for instance, limiting access to a subscriber account (information for which is stored in a subscriber accounts file 520 of a an account data store 518) to access requests transmitted by a primary playback device, for which identifying information is stored in subscriber accounts file 520, or to access requests complying with the rules and information for alternative/additional access to content or services. As a more specific illustrative example, secondary access can be conditioned on receiving predetermined login credentials (e.g., username, password, identification code, . . . ) over a predetermined communication channel (e.g., e-mail, mobile voice call, IP voice call, text message, short message service message, multimedia message service message, . . . ) from a predetermined secondary access device (e.g., a mobile phone, a predetermined media access control [MAC] address, . . . ), or a subset thereof. This information related to secondary access can be stored in remote login data store 510 at a login credentials file 512, remote communication channels file 514 or secondary playback devices file 516, respectively. It should be appreciated that the secondary media playback device can comprise any suitable media display device, including a television, media player, computer, mobile phone, smart phone, tablet computer, and so on. Although the term “secondary media playback device” may imply a primary media playback device, this need not be the case, and instead the term “secondary media playback device” can refer to accessing content or services over a predetermined communication channel instead, with any suitable device facilitating the communication over such channel. In particular aspects, a secondary media playback device can be a predetermined device communicating over a predetermined communication channel. Further, the predetermined communication channel can comprise any suitable channel for electronic communication over a network. Although a remote communication channel might imply a mobile communication channel through which a user can communicate while traveling or otherwise away from fixed communications (e.g., home or office computer, . . . ), the remote communication channel need not be limited to this implication, and other examples of a remote communication channel can be employed instead.

Thus, upon receiving a login request, account authorization apparatus 508 can reference subscriber accounts file 520 to determine if a subscriber account exists that matches information included in the login request. If so, analysis of a device transmitting the request can be conducted, to determine if the device is a primary access device (specified in subscriber accounts file 520), or a suitable secondary access device stored in secondary playback devices 516. In the former case, the request can be granted and access to promotional content or services 522 linked with the subscriber account provided in response to the device matching the primary access device. If the device is not the primary access device, a communication channel over which the request is received can be matched to remote communication channel information stored in remote communication channel file 514 associated with the subscriber account, if any. If the remote communication channel matches a predetermined communication channel, login credentials and information pertaining to a secondary access device can be referenced to determine whether the request matches this information. In response to a match, access to linked promotional content or services 522 can be provided in response to the request, facilitating remote playback of content over the communication channel on the secondary access device.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include account authorization apparatus 402 comprising remote login data store 510 and account data store 518, communicatively connected with selective provisioning apparatus 202 which in turn comprises authorization component 318, DRM component 418 and secondary access component 506, as one possible example. Sub-components could also be implemented as components electrically connected to other sub-components rather than included within a parent component. Additionally, it should be noted that two or more components could be combined into a single component providing aggregate functionality. For instance, parsing component 206 can comprise provisioning component 212 to facilitate identifying client-selected authentication and allocating content or services based on the identified client-selected authentication, by way of a single component. Components of the disclosed systems and apparatuses can also interact with one or more other components not specifically described herein but known by those of skill in the art, or made known to one of skill in the art by way of the context provided herein.

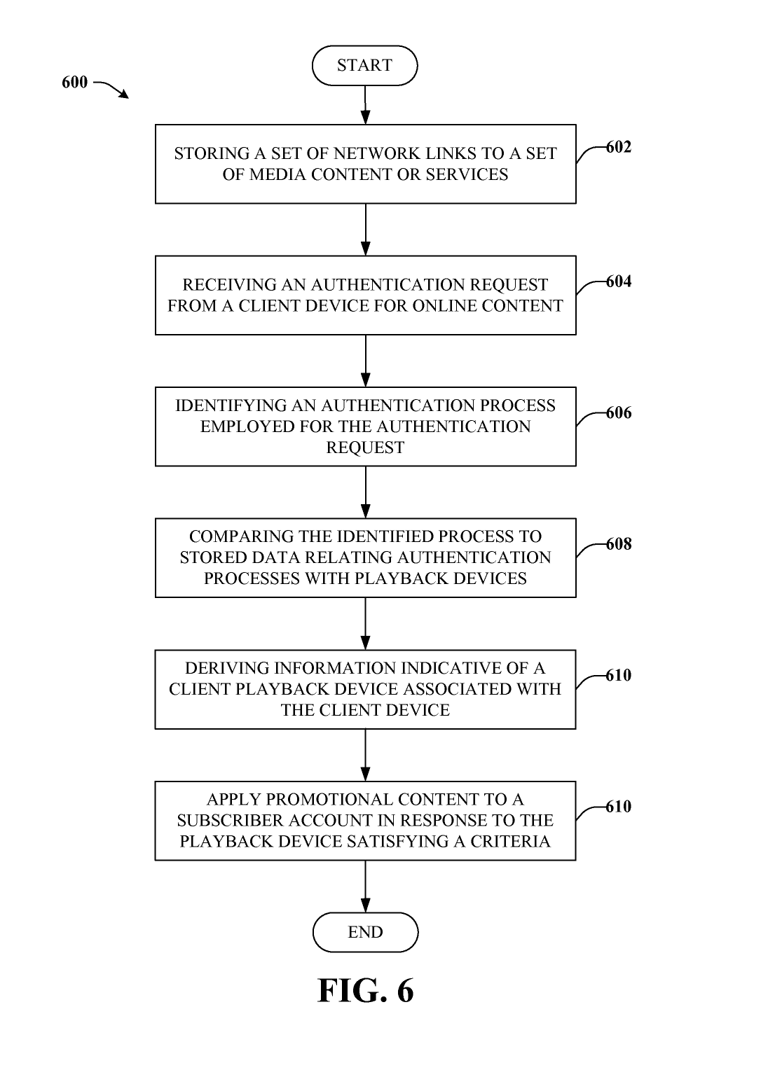

In view of the exemplary diagrams described supra, process methods that may be implemented in accordance with the disclosed subject matter will be better appreciated with reference to the flow chart of FIGS. 6-8. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 6 illustrates a flowchart of an example method 600 according to one or more additional aspects of the subject disclosure. At 602, method 600 can comprise storing (e.g., by a system including at least one processor) a set of network links to a set of media content or services. The set of media content or services can comprise, for instance, a subset of content or services available from an online multimedia content provider (e.g., an online television content provider, online email content provider, online text messaging provider, . . . ). Further, the set of network links can comprise hypertext markup language (HTML) links, universal resource locator (URL) links, etc.

At 604, method 600 can comprise receiving (e.g., by the system) an authentication request from a client device related to accessing online content. The authentication request can be included within a client-server communication over a network, as one example. Moreover, the online content can be related to content or services maintained by the online multimedia content provider and made available to consumers via subscriber accounts or other suitable mechanism.

At 606, method 600 can comprise identifying (e.g., by the system) an authentication process employed for the authentication request. The authentication process can be a local authentication process (e.g., conducted by a client device for verifying a user is a human, rather than a computer or bot) or a remote authentication process (e.g., conducted via a client-server interaction). In at least one aspect of the subject disclosure, the authentication process can comprise a query for a video identification code for display to a user on a display device associated with the client device.

At 608, method 600 can comprise comparing (e.g., by the system) the identified authentication process to stored data that relates a set of authentication processes with a set of multimedia playback devices. The relationship can comprise, for instance, a matrix or other suitable two-dimensional grid linking subsets of authentication processes with respective subsets of multimedia playback devices. In at least one aspect, the association can be based at least in part on video processing technology employed by respective multimedia playback devices, and respective subsets of authentication processes that are compatible with the respective video processing technology.

Further, at 610, method can comprise deriving (e.g., by the system) information indicative of a client multimedia playback device associated with the client device in response to the comparing. The information can be derived, as one example, as an inference that the client multimedia playback device is one or more multimedia playback devices correlated with the identified authentication process by the stored data that relates the set of authentication processes with the set of multimedia playback devices. The information indicative of the client multimedia playback device can be utilized to perform one or more actions suitable to the client multimedia playback device. One example can include allocating multimedia content to an associated subscriber account that is compatible with, adapted for, or particularly suited to the client multimedia playback device. As a more specific example, in response to determining the client multimedia playback device is a high definition, 1080p standard network-enabled television, allocating multimedia content can comprise allocation a subset of content that is compatible with the 1080p standard, for view on the high definition playback device).

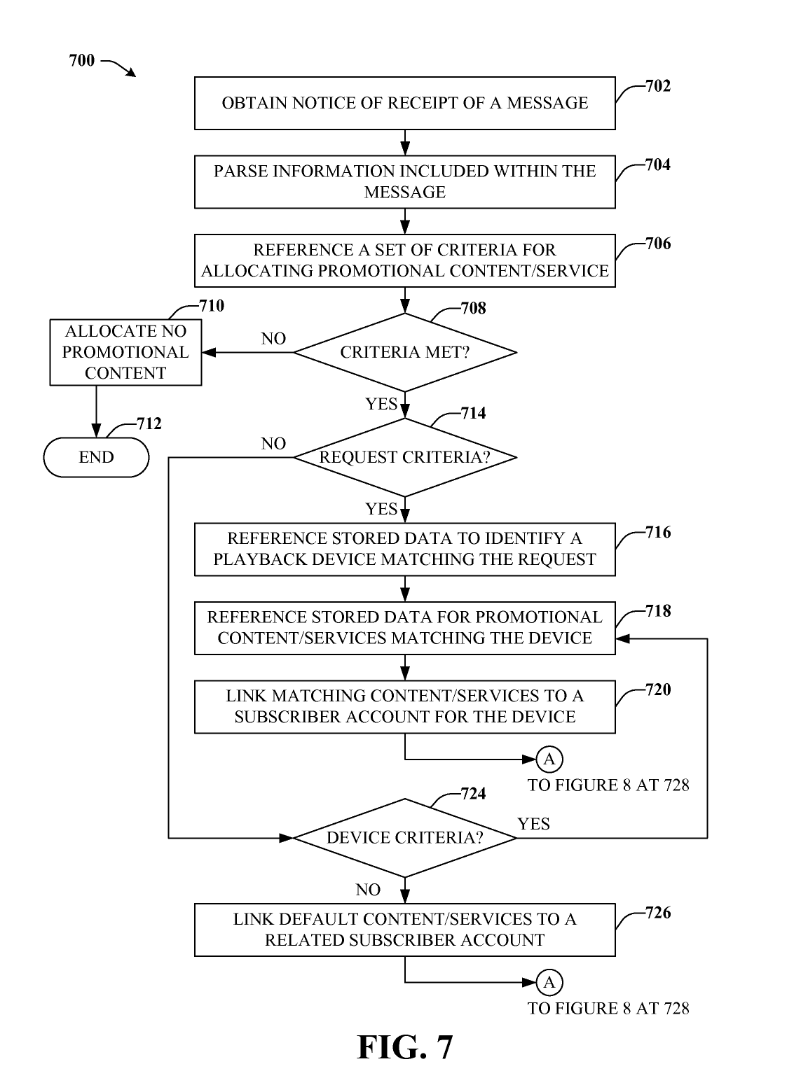

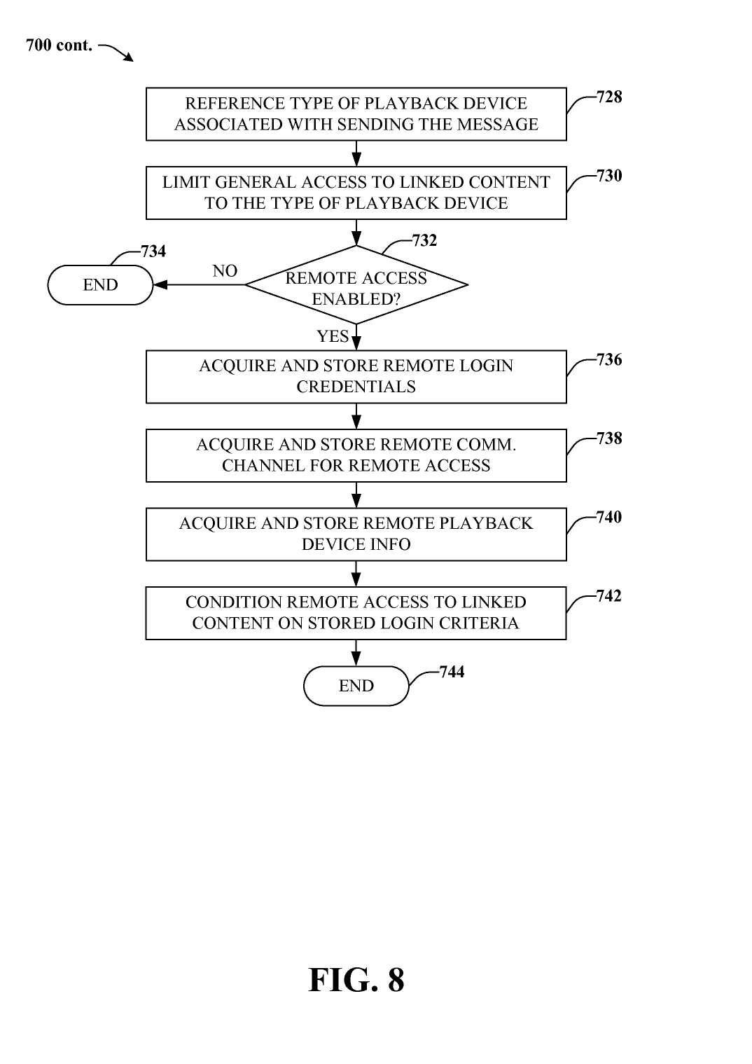

FIGS. 7 and 8 illustrates a flowchart of an example method 800 for allocating promotional content or services in response to client-selected account authorization communication related to multimedia content acquisition, according to one or more specific aspects of the subject disclosure. At 702, method 800 can comprise obtaining notice of receipt of a message at a network server. In one instance, the network server can comprise an access authorization entity related to the multimedia content acquisition. At 704, method 700 can comprise parsing information included within the message. At 706, method 700 can comprise referencing a set of criteria for allocating promotional content or services in response to authorizing access to online multimedia content.

At 708, method 700 can comprise determining whether one or more of the set of criteria are met. If not, method 700 can proceed to 710 and allocate no promotional content in response to receiving the message, and end at 712. Otherwise, if one or more of the set of criteria are met, method 700 can proceed to 714.

At 714, method 700 can comprise determining whether an authorization request criteria has been met. Authorization request criteria can comprise one or more conditions related to an authorization request for accessing content or services, or an authentication request related to verify a user of a device. If authorization request criteria has indeed been met, method 700 can proceed to 716. Otherwise, method 700 proceeds to 724.

At 716, method 700 can comprise referencing stored data to identify a playback device matching the authorization request. Utilizing the stored data, a type of client playback device associated with transmission of the message can be identified. The type of client playback device can be distinguished by a media processing capability, network communication capability, media playback feature (e.g., video resolution), device model number, device class (e.g., television, multi-purpose computer, tablet computer, . . . ) or the like, or a suitable combination thereof. At 718, method 700 can comprise referencing stored data for promotional content/services matching the playback device identified at reference number 716. At 720, method 700 can comprise linking matching promotional content/services with a subscriber account associated with the playback device. From 720, method 700 can proceed to 728 at FIG. 8, infra.

At 724, method 700 can comprise determining whether a playback device criteria has been met. This determination can comprise analyzing information within the message, or information pertaining to the message, for information indicative of the playback device. If playback device criteria has been met, method 700 can return to reference number 718; otherwise method 700 can proceed to 726 and can comprise linking a default set of content/services to a subscriber account related to the message. From 726, method 700 can proceed to 728 at FIG. 8, infra.

Referring now to FIG. 8, method 700 is continued at 728. Particularly, at 728, method 700 can comprise referencing a type of playback device associated with a client device transmitting the message. At 730, method 700 can comprise limiting general access to linked promotional content/services at least in part based on the type of playback device.

At 732, method 700 can comprise determining whether remote access is enabled for the subscriber account. If remote access is enabled, method 700 can proceed to 736. Otherwise, method 700 can end at 734.

At 736, method 700 can comprise acquiring and storing remote login credentials for the subscriber account. At 738, method 700 can comprise acquiring and storing remote communication channel information for remote access at least to the promotional content or services allocated to the subscriber account. At 740, method 700 can comprise acquiring and storing remote playback device information (e.g., a secondary playback device) for validating a request for remote access over the remote communication channel. At 742, method 700 can comprise conditioning remote access to linked promotional content/services on satisfaction of stored remote login criteria. At 744, method 700 can end.

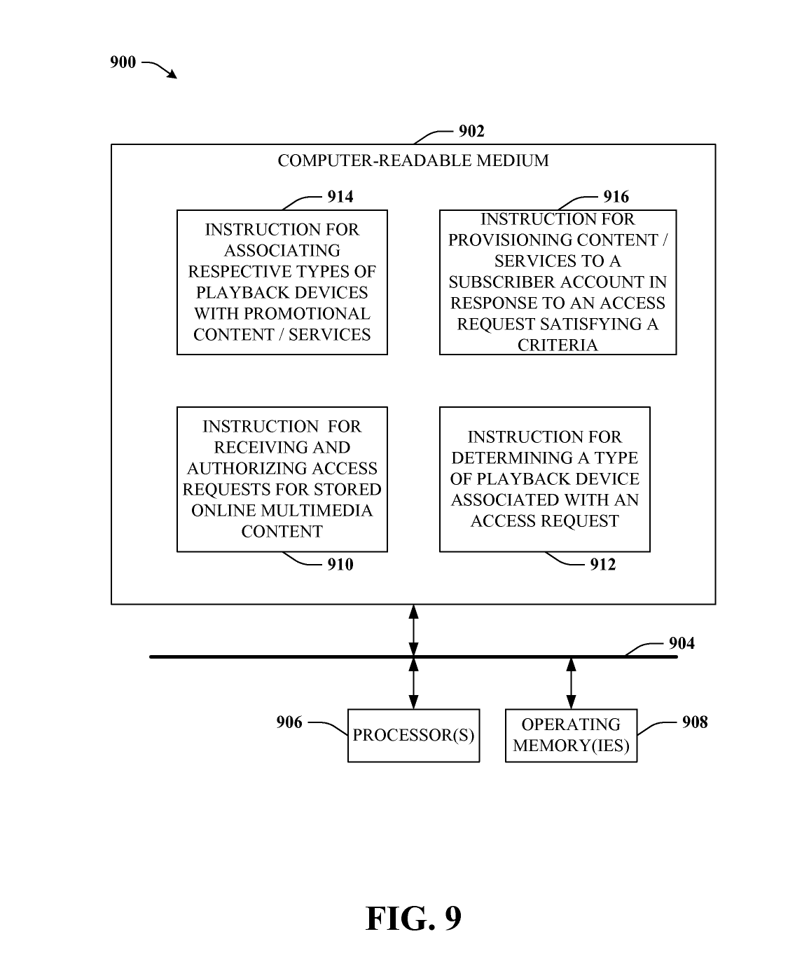

FIG. 9 illustrates an example apparatus 900 for implementing client-selected authorization-based content allocation for online content or service acquisition, according to further aspects of the subject disclosure. For instance, apparatus 900 can reside at least partially within a communication network or within a network server such as a network node, network gateway, terminal device, personal computer coupled with a network interface card, or the like. It is to be appreciated that apparatus 900 is represented as including functional blocks, which can be functional blocks that represent functions implemented by a hardware, software, or combination thereof (e.g., firmware). In some aspects, the functional blocks can represent non-transitory computer-readable media. In other aspects, the functional blocks can represent transitory computer-readable media.

Apparatus 900 can comprise a computer-executable medium 902 comprising one or more computer-executable instructions that can be accessed over a data communication interface 904. Data communication interface 904 can include a communication bus, a media reader (e.g., disc reader, disk reader, drive reader, . . . ), a data ribbon, a wired data interface, a wireless data interface, a network communication interface, a network signaling interface, or a suitable combination thereof. Additionally, the computer-executable instructions can be stored in an operating memory 908 or executed by a processor 906 to facilitate functionality of apparatus 900.

As depicted, computer-executable medium 902 can comprise a first computer-executable instruction 910 for receiving and authorizing access requests for stored online multimedia content. Additionally, computer-executable medium 902 can comprise a second computer-executable instruction 912 for determining a type of playback device submitting an access request. The determination can be based on analysis of data contained within the access request, analysis of data pertaining to the access request, a type of access request and stored information indicative of types of playback devices compatible with respective types of access requests, or the like, or a suitable combination thereof.

In addition to the foregoing, computer-executable medium 902 can comprise a third computer-executable instruction 914 for associating respective types of playback devices with respective subsets of promotional content or services related to stored online multimedia content. Further, computer-executable medium 902 can comprise a fourth computer-executable instruction 916 for provisioning a subset of promotional content or services to a subscriber account related to stored online multimedia content. Particularly, the provisioning can be in response to determining an access request submitted in conjunction with the subscriber account satisfies a criteria related to provisioning the subset of promotional content or services. In at least one aspect, the criteria can be related to identifying a client-based playback device being one of a set of playback device types (e.g., a network-enabled television, a high definition television, a video display device with high definition processing and display capabilities, . . . ).

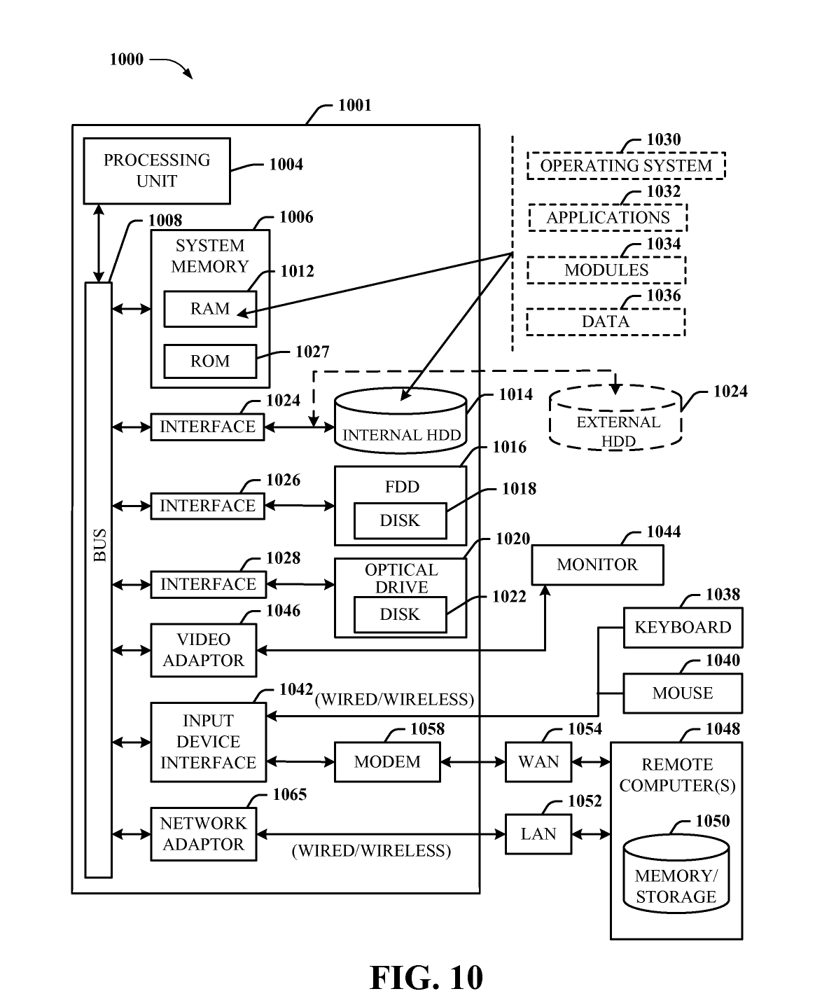

With reference to FIG. 10, an exemplary environment 1000 for implementing various aspects described herein includes a computer 1002, the computer 1002 including a processing unit 1004, a system memory 1006 and a system bus 1008. The system bus 1008 connects system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that aspects of the subject disclosure can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 through an interface, such as a video adapter 1046. In addition to the monitor 1044, a computer typically includes other peripheral output devices (not shown), such as speakers, printers, etc.

The computer 1002 can operate in a networked environment using logical connections by wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or can be connected to a communications server on the WAN 1054, or has other means for establishing communications over the WAN 1054, such as by way of the Internet. The modem 1058, which can be internal or external and a wired or wireless device, is connected to the system bus 1008 through the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

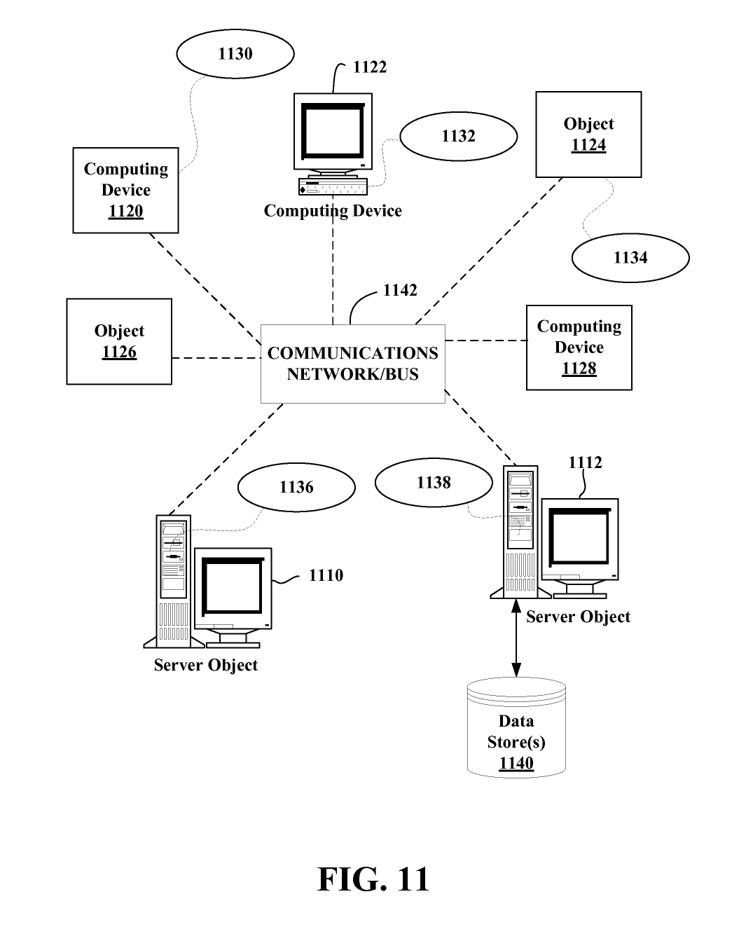

FIG. 11 provides a schematic diagram of an exemplary networked or distributed computing environment. The distributed computing environment comprises server objects 1110, 1112, etc. and computing devices or objects 1120, 1122, 1124, 1126, 1128, etc., which may include programs, methods, data stores, programmable logic, etc., as represented by applications 1130, 1132, 1134, 1136, 1138 and data store(s) 1140. It can be appreciated that server objects 1110, 1112, etc. and computing devices or objects 1120, 1122, 1124, 1126, 1128, etc. may comprise different devices, including account authorization apparatus 102 or similar entities depicted within the illustrations, or other devices such as a network-enabled display device, network-enabled television, set-top box with network connection and display, satellite receiver and display, mobile phone, personal digital assistant (PDA), audio/video device, MP3 players, personal computer, laptop, etc. It should be further appreciated that data store(s) 1340 can include data store 118, or other similar data stores disclosed herein.

Each server object 1110, 1112, etc. and computing devices or objects 1120, 1122, 1124, 1126, 1128, etc. can communicate with one or more other server objects 1110, 1112, etc. and computing devices or objects 1120, 1122, 1124, 1126, 1128, etc. by way of the communications network 1142, either directly or indirectly. Even though illustrated as a single element in FIG. 11, communications network 1142 may comprise other computing objects and computing devices that provide services to the system of FIG. 11, or may represent multiple interconnected networks, which are not shown. Each server object 1110, 1112, etc. or computing device or object 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by account authorization apparatus 102, 402, 508 or selective provisioning apparatus 202, 302, 502 for communicating with a network. The “client” is a member of a class or group that uses the services of another class or group to which it is not related. A client can be a process, e.g., roughly a set of instructions or tasks, that requests a service provided by another program or process. The client process utilizes the requested service, in some cases without having to “know” any working details about the other program or the service itself. A client device can be a computing device or object 1120, 1122, 1124, 1126, 1128 upon which a client process operates or is executed, in one or more disclosed aspects.

In a client/server architecture, particularly a networked system, a client is usually a computer that accesses shared network resources provided by another computer, e.g., a server. In the illustration of FIG. 11, as a non-limiting example, computing devices or objects 1120, 1122, 1124, 1126, 1128, etc. can be thought of as clients and server objects 1110, 1112, etc. can be thought of as servers where server objects 1110, 1112, etc., acting as servers provide data services, such as receiving data from client computing devices or objects 1120, 1122, 1124, 1126, 1128, etc., storing of data, processing of data, transmitting data to client computing devices or objects 1120, 1122, 1124, 1126, 1128, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1342 or bus is the Internet, for example, the server objects 1110, 1112, etc. can be Web servers with which other computing devices or objects 1120, 1122, 1124, 1126, 1128, etc. communicate via any of a number of known protocols, such as the hypertext transfer protocol (HTTP). Server objects 1110, 1112, etc. acting as servers may also serve as clients, e.g., computing devices or objects 1120, 1122, 1124, 1126, 1128, etc., as may be characteristic of a distributed computing environment.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect, embodiment or design described herein as “exemplary”, “demonstrative”, “illustrative”, or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system for managing online content, comprising:
a memory storing computer-executable components; and
a processor communicatively connected to the memory and configured to facilitate execution of at least one of the computer-executable components, the computer-executable components comprising:
a communication component configured to receive a message from a client device that includes a request related to authorization to access content;
a parsing component configured to search the message for information satisfying a criterion related to selective provision of a subset of content or services to subscriber accounts associated with consumption of the content; and
a provisioning component configured to link a service or content from the subset of content or services with a subscriber account associated with the client device, at least in part in response to the parsing component finding information pertaining to the message that satisfies the criterion.

2. The system of claim 1, wherein the criterion relates to a media playback device associated with the client device or with the subscriber account.

3. The system of claim 2, wherein the criterion further relates to the media playback device being one of a set of predetermined types of media playback devices.

4. The system of claim 3, wherein the set of predetermined types of media playback devices includes a network-enabled television device.

5. The system of claim 3, wherein the set of predetermined types of media playback devices excludes a personal computer, a laptop computer or a workstation computer.

6. The system of claim 3, wherein the parsing component is configured to further search the message for type information indicative of a type of the media playback device and the provisioning component is configured to link the service or content to the subscriber account in response to the type of the media playback device matching one of the set of predetermined types of media playback devices.

7. The system of claim 2, wherein the criterion further relates to a video processing mechanism of the media playback device being one of a set of predetermined video processing mechanisms.

8. The system of claim 7, wherein the set of predetermined video processing mechanisms includes an operating system-based processing mechanism, an application-based processing mechanism or a browser-based processing mechanism.

9. The system of claim 7, wherein the parsing component is configured to further search the message for mechanism information indicative of a video processing mechanism employed by the media playback device and the provisioning component is configured to link the service or content to the subscriber account in response to the video processing mechanism matching one of the set of predetermined video processing mechanisms.

10. The system of claim 1, wherein the criterion pertains to the request related to authorization to access the content.

11. The system of claim 10, wherein the criterion further pertains to the request comprising a query for a video identification code to facilitate user authentication at the client device or a media playback device associated with the client device.

12. The system of claim 10, wherein the parsing component is configured to further search the message for query information indicative of a query for a video identification code and the provisioning component is configured to link the service or content to the subscriber account at least in part in response to the message comprising the query for the video identification code.

13. The system of claim 1, the computer-executable components further comprising an authorization component configured to, in response to the parsing component identifying a query for a video identification code within the message, generate an authorization code for the client device, create a picture file comprising a picture of the authorization code, and convert the picture file into a video file.

14. The system of claim 13, wherein the communication component transmits the video file in response to the message and facilitates access to the content in response to reception of a transmission comprising the authorization code prior to expiration of a predetermined time.

15. The system of claim 1, wherein the provisioning component is configured to flag the subscriber account to limit playback of the linked service or content to a media playback device associated with the client device or the subscriber account.

16. The system of claim 15, wherein the subscriber account is flagged to permit the media playback device to access the linked service or content in response to the media playback device being a network-enabled television device.

17. The system of claim 5, wherein the subscriber account is flagged to permit access to the linked service or content to a remote login device linked to the subscriber account.

18. The system of claim 1, the computer-executable components further comprising a digital rights management (DRM) component that encodes the linked service or content according to a DRM protocol.

19. The system of claim 1, wherein the content comprises a set of video files for playback at a reduced playback fee.

20. The system of claim 1, wherein the service comprises access to an online application hosted by the system or an associated third party entity, access to preferred billing or account management functions associated with the subscriber account, access to digital coupons or credits associated with the content or a third party content provider, or a combination thereof.

21. The system of claim 1, the computer-executable components further comprising a secondary access component configured to establish remote login functionality for the subscriber account, wherein the remote login functionality stores information and rules for accessing the linked service or content at a remote media display device associated with a second client device.

22. The system of claim 21, wherein stored information comprises subscriber authorization credentials, and a communication channel for requesting access to the linked service or content.

23. The system of claim 22, wherein the communication channel comprises an email transmission, a mobile voice call, a text message, an instant message, a short message service message or a multimedia message service message.

24. The system of claim 21, where the rules for accessing the content provide access to the linked service or content in response to receipt of a login transmission for accessing the linked service or content over a predetermined communication channel, receipt of login credentials with the login transmission, and a determination that the login credentials match stored subscriber authorization credentials for the remote login functionality.

25. The system of claim 24, wherein the login credentials at least in part comprise a digital certificate and wherein the determination that the login credentials match the subscriber authorization credentials further comprises matching the digital certificate to stored digital certificate data.

26. A method for managing online content, comprising:
storing, by a system including at least one processor, a set of network links to a set of media content or services;
receiving, by the system, an authentication request from a client device related to accessing online content;
identifying, by the system, an authentication process employed for the authentication request;
comparing, by the system, the identified authentication process to stored data that relates a set of authentication processes with a set of multimedia playback devices; and
deriving, by the system, information indicative of a client multimedia playback device associated with the client device in response to the comparing.

27. The method of claim 26, further comprising transmitting, by the system, a subset of the network links to a communication account associated with the client device.

28. The method of claim 27, further comprising activating, by the system, a subset of the media content or services corresponding with the subset of the network links for consumption by the client multimedia playback device.

29. The method of claim 27, further comprising selecting, by the system, the subset of the network links from the set of network links at least in part based on the information indicative of the multimedia playback device.

30. The method of claim 26, further comprising determining, by the system, whether the identified authentication process comprises a video authentication process.

31. The method of claim 30, further comprising activating, by the system, a subset of the set of media content or services selected for the video authentication process for consumption by the client device in response to determining the authentication process comprises the video authentication process.

32. The method of claim 26, further comprising determining, by the system, whether the authentication process relates to a video processing technology employed by the client multimedia playback device.

33. The method of claim 32, further comprising activating, by the system, a subset of the set of media content or services selected for the video processing technology employed by the client multimedia playback device for consumption by the client device, in response to determining that the authentication process relates to the video processing technology employed by the client multimedia playback device.

34. The method of claim 26, further comprising facilitating access, by the system, to a subset of the set of media content or services for a second client device over a mobile communication channel.

35. The method of claim 34, further comprising provisioning, by the system, a digital certificate for authorizing access to the subset of the set of media content or services to the second client device over the mobile communication channel.

36. A system for managing online content, comprising:
means for receiving and authorizing access requests for stored online multimedia content;
means for determining a type of playback device submitting an access request;
means for associating respective types of playback devices with respective subsets of promotional content or services related to stored online multimedia content; and
means for provisioning a subset of promotional content or services to a subscriber account related to stored online multimedia content in response to determining an access request submitted in conjunction with the subscriber account satisfies a criterion related to provisioning the subset of promotional content or services.

37. The system of claim 36, further comprising:
means for determining a type of the access request submitted in conjunction with the subscriber account; and
means for relating a set of access requests with a set of playback devices types, wherein the means for determining the type of playback device employs the type of the access request to identify a related playback device type.

38. The system of claim 37, wherein the type of the access request comprises a video identification code authentication request.

39. The system of claim 36, wherein the subsets of promotional content or services comprises one or more free videos, movies, or songs for playback by the type of playback device submitting the access request.

40. The system of claim 36, further comprising means for establishing access to the subset of promotional content or services over a mobile communication channel.

41. The system of claim 36, further comprising means for establishing access to the subset of promotional content or services on a mobile playback device of a different type than the type of playback device submitting the access request.

42. A non-transitory computer readable storage medium comprising computer-executable instructions that, in response to execution, cause a computing system including a processor to perform operations, comprising:
obtain, by the computing system, a video processing technology of a video playback device associated with the computing system;
reference, by the computing system, a mode of user authentication particular to the video processing technology of the video playback device;
submit, by the computing system, a request related to a user authentication procedure to an authorization server associated with granting or denying access to online content; and
receive, by the computing system, a response to the request comprising information particular to the user authentication procedure and usable in conjunction with the mode of user authentication particular to the video processing technology.

43. The non-transitory computer readable storage medium of claim 42, further comprising implement, by the computing system, the mode of user authentication at the video playback device at least in part to facilitate access to the online content.

44. The non-transitory computer readable storage medium of claim 42, further comprising reference, by the computing system, a digital rights management credential of the video playback device.

45. The non-transitory computer readable storage medium of claim 44, further comprising at least one of:
decode, by the computing system, at least a subset of the response in accordance with a digital rights management protocol in response to the video rights management credential of the video playback device satisfying a digital rights management criterion; or
output, by the computer system, a digital rights management error at a display of the video playback device in response to the video rights management credential not satisfying the digital rights management criterion.
